(19) United States
(12) Patent Application Publication
(10) Pub. No.: US 2026/0095805 A1
(43) Pub. Date: Apr. 2, 2026

(54) SYSTEM FOR MONITORING QUALITY OF SERVICE AND LATENCY OF A CELLULAR NETWORK AND RELATED METHODS

(71) Applicant: LATENCE TECHNOLOGIES INC., Montreal (CA)

(72) Inventors: Benoit GENDRON, Montreal (CA); Nicolas GORSE, Outremont (CA)

(21) Appl. No.: 19/112,008

(22) PCT Filed: Dec. 27, 2023
(86) PCT No.: PCT/CA2023/051765

§ 371 Date: Mar. 14, 2025

Related U.S. Application Data
(60) Provisional application No. 63/477,451, filed on Dec. 28, 2022.

(51) Int. Cl. H04W 28/02; H04L 41/16; H04W 24/02

(52) U.S. Cl. CPC H04W 28/0236; H04L 41/16; H04W 24/02

(57) ABSTRACT

A method and a system for monitoring a quality of service (QoS) of a cellular network are provided. The method includes generating, using a monitoring module, test data based on latency parameters, the test data comprising initial test packets, and transmitting the initial test packets of the test data to a target module. The method includes transmitting, using the target module, redirected test packets back to the monitoring module, the redirected test packets associated with the initial test packets. The method further includes processing, using the monitoring module, the redirected test packets to calculate latency measurements between transmission of the initial test packets and reception of the redirected test packets. The method also includes transmitting the latency measurements to a processing module comprising a QoS neural network; and producing at least one of a current latency state and a future latency state using the QoS neural network.

### TECHNICAL FIELD

The technical field generally relates to telecommunication networks, and more specifically to systems for monitoring the quality of service (QoS) and latency of a wireless network, as well as related methods.

### BACKGROUND

The criticality of new services using or relying on cellular networks, such as LTE and 5G networks, requires communications between components to be near-instantaneous, preferably with little latency or ideally without any latency at all. More specifically, some technical fields require remote control or automation, two applications that may be potentially negatively impacted by latency itself and by latency variations. Non-imitative examples of such technical fields are telemedicine, remote operation of equipment and autonomous transportation. In these technical fields, the tolerance (i.e., deviation from a predetermined value or standard) is relatively low, and a relatively low latency is preferred or even required, since a relatively high latency or variation thereof may render these services unusable or even dangerous.

In light of the above, there is a need to monitor and measure latency in a 5G network and other wireless networks to predict and/or guarantee the security and efficiency of using these new services.

### SUMMARY

According to an aspect, there is provided a method for monitoring a quality of service (QoS) of a cellular network. The method includes generating a plurality of real-time and continuous test data via a monitoring server or module, the plurality of test data being based on latency parameters to be measured. for each test data, the method includes sending, from the monitoring server, an initial test packets of the test data to a target device or module; upon reception of the initial test packets at the target device, redirecting the initial test packets back to the monitoring server; and upon reception of the redirected test packets at the monitoring server, processing, with the monitoring server, the redirected test packets to obtain latency measurements between the transmission of the initial test packets and the reception of the redirected test packets; upon obtaining the latency measurements of the test data, transmitting the latency measurements to a processing server or module. The method also includes receiving, at the processing server, the transmitted latency measurements in a QoS neural network, the QoS neural network being continuously trained with the transmitted latency measurements and latency measurements representative of past measurements; and producing a current latency state and/or a future latency state.

According to another aspect, there is provided a system for monitoring a quality of service (QoS) of a 5G network. The system includes a monitoring server or module, the monitoring server being configured to generate a plurality of test data, the plurality of test data being based on latency parameters to be measured. The system also includes a target device or module operatively connected to the monitoring module, target device being configured to, for each test data: receive, from the monitoring server, an initial test packets of the test data; upon reception of the initial test packets, redirect the initial test packets back to the monitoring server; and send the redirected test packets to the monitoring server, the monitoring server being configured to process the redirected test packets to obtain latency measurements between the transmission of the initial test packets and the reception of the redirected test packets. The system also includes a processing server or module operatively connected to the monitoring server, the processing server being configured to receive transmitted latency measurements in a QoS neural network, the QoS neural network being continuously trained with the transmitted latency measurements and latency measurements representative of past measurements, the processing server being configured to produce a current latency state and/or a future latency state.

### BRIEF DESCRIPTION OF THE DRAWINGS

FIG. 1 is a block diagram of a system for monitoring a quality of service (QoS) of a network, according to an embodiment.

FIG. 2 is a flowchart illustrating a method for monitoring a quality of service (QoS) of a network, according to an embodiment.

FIG. 3 is a diagram illustrating transmission and reception steps of the method of FIG. 2, according to an embodiment.

FIG. 4 is a flowchart illustrating prediction steps of the method of FIG. 3, according to an embodiment.

FIGS. 5 to 9 are schematics illustrating screenshots of a graphical user interface (GUI) for display on a user's device in the system of FIG. 1, according to an embodiment.

### DETAILED DESCRIPTION

In the present description, similar features in the drawings have been given similar reference numerals. To avoid cluttering certain Figures, some elements cannot have been indicated if they were already identified in a preceding Figure. It should also be understood that the elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the Figures and should not be considered limiting. More particularly, it will be understood that such spatially relative terms are intended to encompass different orientations in the use or operation of the present embodiments, in addition to the orientations exemplified in the Figures.

The terms “a”, “an” and “one” are defined herein to mean “at least one”, that is, these terms do not exclude a plural number of items, unless stated otherwise.

Terms such as “substantially”, “generally” and “about”, which modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

Expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

The present description broadly relates to techniques, including methods and systems, for monitoring the quality of service (QoS) of a cellular network. The term “network(s)” herein generally refers to “telecommunication network(s)” and in some embodiments to “cellular network(s)”. Such cellular networks include a plurality of nodes in operative communication with each other (i.e., each node can communicate, and preferably wirelessly communicate, with at least one other node and, preferably, with a plurality of other nodes). Examples of cellular networks include, but are not limited to, broadband cellular networks, such as Long-Term Evolution (LTE) networks and fifth generation (5G) networks. Of note, in the context of the present disclosure, the terms “node”, or “network node”, including synonyms, similar expressions and/or derivatives thereof, refer to a distribution/redistribution endpoint and/or a communication endpoint within the cellular network. A node can include any device(s) adapted to create, receive, store, and send data along the cellular network, such as, for example and without being limitative, routers, computers, switches, servers, Internet of Things (IoT) devices, and/or combinations thereof. In some implementations, a node can be configured to process a network signal and transmit the same to other devices in the cellular network.

The expression “quality of service” as used herein, as well as synonymous expressions and derivatives thereof, refers to the control of the performance, reliability, and usability of the telecommunication or cellular network. For instance, QoS can include the management of the network resources such as, for example and without being limitative, data traffic to reduce packet loss, latency and/or jitter of the network.

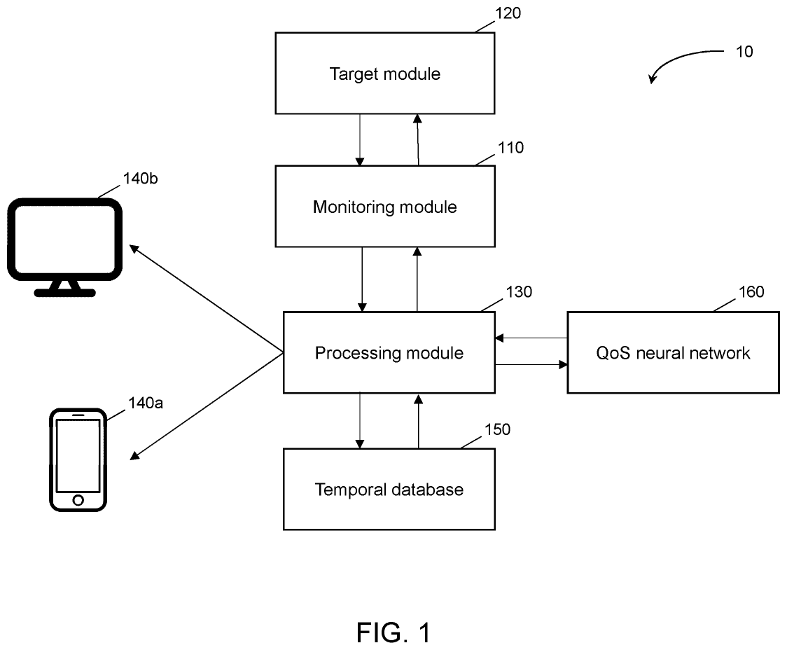

Referring to FIG. 1, there is illustrated an embodiment of a system 10 for monitoring of a quality of service (QoS) of a cellular network. Each component of the system 10 is adapted to perform one or more steps of the monitoring techniques that will be herein described, and the components of the system 10 are collectively or globally adapted for performing the steps allowing the monitoring of the QoS. The system 10 can be configured or adapted to communicate exchange data with component(s) or device(s) within or “inside” the cellular network being monitored (i.e., “internal components”), and, in some embodiments, with component(s) or device(s) external or “outside” the cellular network. For example, the system 10 can communicate, exchange data, or exchange information with one or more user devices, illustrated as user devices 140a, 140b in FIG. 1. The user devices 140a, 140b may, in some embodiments, consist of any device(s) operable to interact with the system 10, or may, in other embodiments, include one or more devices operable to interact with the system 10. As such, the user devices 140a, 140b are in operative connection with one or more components of the system 10, as it will be described in greater detail below. In some embodiments, the user devices 140a, 140b can include devices such as personal computer 140a, smart tablets or phones 140b, and many others. Of note, the user devices 140a, 140b may include or may be operatively connected to a user interface.

Still referring to FIG. 1, the system 10 comprises one or more monitoring modules 110, one or more target modules 120, one or more processing modules 130, a temporal database 150, and a QoS neural network 160. In order to facilitate the presentation of each module, FIG. 1 illustrates an embodiment wherein the system 10 includes one processing module 130, one monitoring module 110, one target module 120, two user devices or interfaces 140a, 140b, one temporal database and one QoS neural network 160. It will have been readily understood that while not illustrated in the Figures, the number of each module included in the system 10 may be different than the ones illustrated in Figure. For example, in some embodiments, it may be desirable, required or necessary to have a plurality of any given modules. As it can be appreciated, the modules 110, 120, 130, which will each be further described below, can be implemented as nodes adapted to operatively communicate with each other, along with other nodes, within the cellular network. Now that the system 10 has been broadly presented, each module of the system 10 will be described in greater detail.

The monitoring module 110 is operatively connected to the target module(s) 120. The monitoring module 110 is configured to interact with the target module(s) 120, to generate measurement requests and to obtain latency measurements of the cellular network. In the context of the present disclosure, the expression “interacting”, including synonymous expressions and derivatives thereof, refers to the fact that the monitoring module 110 is configured to generate or produce test data and send or transmit the test data to the target module 120. Once the test data has been sent or transmitted to the target module 120, the monitoring module 110 is configured to receive or obtain a “response” or “feedback” from the target module 120, as it will be described in greater detail below. As it can be appreciated, the monitoring module 110 is therefore configured to perform “active monitoring” as it continuously generates measurement requests, interact with the target module 120 and handles the results.

In some embodiments, generating the test data can be carried out based on one or more latency parameters. In some embodiments, the monitoring module 110 can be configured to define latency parameters, which may for example include a “type” of measurements (i.e., a class of measurements) and a frequency to which the measurements can be obtained or collected. For example, and without being limitative, the measurement type can include the type of protocol that is to be created (i.e., generated or produced) and measured. The frequency can include the data transmission interval. The data transmission interval can include at what time interval the data should be transmitted or how long the test data should be transmitted. As such, the frequency may be used to define “measurements cycles”, i.e., time-dependent patterns according to which a given type of measurement is carried out. In other embodiments, the latency parameters may be obtained or defined a priori. In these embodiments, the system 10 may include a local memory or database or may be operatively connected to an external memory or database, and the local memory or database or the external memory or database may be configured to store calibration data representative of latency parameters. The calibration data may be based on empirical data, analytical data, historical data, models or any combinations thereof.

The step of sending the test data carried out by the monitoring module 110 can include sending, or transmitting, data (or information) via the cellular network to the target module 120. In some embodiments, the transmission of test data may include transmitting test packets to the target module 120. The expression “test packets”, including synonymous expressions and derivatives thereof, herein refers to network packets associated with the test data, i.e., a segmented internet protocol message divided into packets. In the context of the present disclosure, the packets sent by the monitoring module 110 will sometimes be referred to as “initial test packets”, as they were initially sent by the monitoring module 110, and can be associated with the original test data. The step of receiving a response from the target module 120, as carried out by the monitoring module 110 can include receiving redirected test packets. The redirected test packets associated with the measurable test data can include test packets generated by the target module 120, before being sent back (or “resent”) to the monitoring module 110.

In some embodiments, the monitoring module 110 can be configured to process the redirected test packets. The processing of the redirected test packets can include obtaining a latency measurement based on the test packets. In some embodiments, obtaining the latency measurement can be carried out by estimating, calculating or computing the period between the transmission of the initial test packets and the reception of the redirected test packets (i.e., a duration between the moment at which the initial test packets are transmitted and the moment at which the redirected test packets are received). The monitoring module 110 can also be configured to send the obtained latency measurements to the processing module 130.

In some embodiments, the monitoring module 110 can include a monitoring server, such as, for example and without being limitative, a single server or cluster of servers. In some embodiments, the monitoring server may be deployed or implemented, in part, in a local network. The monitoring server can be implemented as a virtual container deployed on a cellular modem, such as a 5G modem. It will have been readily understood that other configurations are possible.

The monitoring server can be configured to bridge between devices within the local network and the cellular network. In some embodiments, the monitoring module 110 can be implemented as an edge node/server between the local network and the cellular network. By being implemented as an edge node/server between the local network and the cellular network, the monitoring module is configured to enable communication between the local network devices and other nodes in the cellular network, i.e., one of the target module(s) 120, the processing module(s) 130, or other devices in the cellular network.

As can be appreciated, in some embodiments, the monitoring module 110 can be configured to communicate with other monitoring modules in the cellular network. For example, and without being limitative, the monitoring module 110 can act as a relay between another monitoring module (not illustrated) and a target device (not illustrated). For example, in some embodiments, the monitoring module 110 can receive test packets from the other monitoring module (not illustrated) implemented at another location and relay the received test packets to a corresponding target device (not illustrated) which is in communication with the other monitoring module (not illustrated). Similarly, the target module 130 can receive the redirected test packets and redirect them to the other monitoring module, or any other modules, depending on the targeted application.

The target module 120, also herein referred to as a “reflector module” or a “redirection module”, can be configured to interact with the monitoring module 110. The term “target module”, herein refers to a module configured to be used as a target for QoS measurements by the monitoring module 110. Broadly described, the target module 120 is configured to receive and redirect the test packets to the monitoring module 110, which can then be processed by the monitoring module 110 to obtain the latency measurements.

The communication between the monitoring module and the target module takes place via a network link. In other words, a network path (or network segment) is the path through which the monitoring between the different modules 110, 120 takes place within the network. For instance, in some embodiments, Multiple modules could be configured and deployed throughout the network to measure various networks paths or sub-segments of paths of said network.

In some embodiments, the target module 120 can be a target device adapted to redirect data to the monitoring module 110. In some embodiments, the target device can be a server (or a cluster of servers) implemented in a cloud platform. The target device can be virtual, physical or hybrid, and configured to communicate with one or more monitoring modules 110 in the cellular network. As it will have been readily understood, other configurations of the target module 120 are also possible. For example, and without being limitative, the target module 120 can be a software component running on the server or on a separate device, such as a smart phone or tablet, among others. In some embodiments, the target module 120 can be implemented in the same local network as the monitoring module 110.

In some embodiments, the target module 120 can be configured to interact with a single monitoring module 110 in a one-to-one communication configuration. As can be appreciated, in some embodiments, the target module 120 can be configured to interact simultaneously with multiple monitoring modules 110 in a one-to-many communication configurations.

The processing module 130 can be configured to interact with one or more monitoring modules 110. The processing module 130 is configured to receive the latency measurements transmitted by the monitoring module 110. In some embodiments, the processing module 130 is configured as a publish-subscribe (PUB-SUB) server, in which the monitoring module(s) 110 are the subscribers of the processing module 130. The processing module 130 can include a message bus with one or more publish topics, allowing the monitoring modules 110 to connect (or subscribe) to the processing module 130 and transmit latency measurements. For example, the processing module 130 can issue a topic associated with the monitoring module 110. The monitoring module 110 can then transmit the latency measurements to the processing module 130, via the associated topic. It can be appreciated that other configurations are possible.

In some embodiments, the processing module 130 can be configured to label the latency measurements and store them in the temporal database 150. The labelling of the latency measurements can be carried out by associating each latency measurement with an epoch timestamp. In some embodiments, the epoch timestamp corresponds to the time when a latency measurement is received by the processing module 130. For instance, the processing module 130 can label the latency measurement with the following time format: date/hour/minute/second/milliseconds. In some embodiments, other time formats can be considered instead. In some embodiments, the epoch timestamp may be combined with other relevant information.

The processing module 130 is operatively connected to the QoS neural network 160 and is configured to interact with the QoS neural network 160 of the system 10. For instance, the processing module 130 is configured to input latency measurements to the QoS neural network 160. In some embodiments, the inputted measurements can at least in part include latency measurements received from the monitoring module 110, i.e., transmitted by the monitoring module 110 to the processing module 130. In some embodiments, the processing module 130 can output a current latency state and/or a future latency state produced by the QoS neural network 160.

In some embodiments, the processing module 130 is operatively connected to the QoS neural network 160 and the processing module 130 is configured to provide training data for the QoS neural network 160 for the determination of a current and/or future latency state. In some embodiments, the processing module 130 can provide the QoS neural network 160 with a combination of received or obtained latency measurements and past latency measurements, i.e., latency measurements previously obtained and stored in the temporal database 160, as part as the training data to train the QoS neural network 160.

In some embodiments, the processing module 130 may be implemented as a server in the cloud platform. The processing module 130 can be implemented as a single server (or cluster of servers) and can be either physical, virtual or hybrid. In some embodiments, it can be appreciated that the processing module 130 can instead be implemented on the same server as the target module 120.

The processing module 130 can also be configured to provide the output of the current latency state and/or the future latency state to users. In some embodiments, the processing module 130 can include or act as a webserver adapted to provide a web page accessible via the user's devices 140a, 140b (e.g., accessible via a web browser). In some embodiments, other configurations can be considered where a native software component can be running on the user's devices 140a, 140b. The processing module 130 can communicate with the user's devices 140a, 140b via the software component. In some embodiment, the processing module 130 can be configured to provide the current latency state and/or the future latency state via an application programming interface (API) accessible by the user's devices 140a, 140b. Providing an API allows users to extract from the latency state and or future latency state, specific data that they wish to use for display or for other purposes.

As can be appreciated, the communication methods between the different modules 110, 120, 130 can be considered other than on a cellular network. For example, the modules 110, 120, 130 can work and communicate in a similar way in a Wi-Fi wireless network or even in a wired network (i.e., either by cable or by fiber).

The temporal database 150 includes persistent storage data accessible by the processing module 130 and can be configured to store information related to the QoS neural network 160. For instance, the temporal database 150 can keep latency measurements transmitted by the monitoring modules 110 in memory, along with latency measurements derived from past latency measurements, used to train the QoS neural network 160. In some embodiments, the temporal database 150 is either a standalone database or a cluster of databases part of the cloud platform. The temporal database 150 can be implemented as part of a single server or a cluster of servers. In some embodiments, the temporal database 150 can be implemented in the same server as the processing module 130. The database can be a time-series database (TSDB), a non-relational database (NoSQL), a relational database (SQL), or any other types of databases adapted to store latency measurements, or any other data utilised by the components of the system 10.

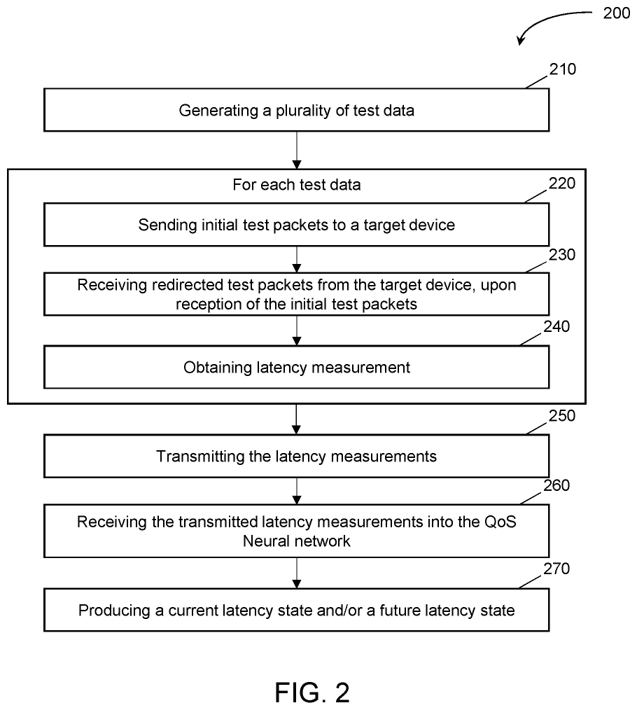

With reference now to FIGS. 2 to 4, a method 200 for monitoring a quality of service (QoS) of a cellular network using the system 10 will be explained, according to a possible embodiment. Broadly described, the method includes obtaining latency measurements using the transmission and reception of test packets, and providing these latency measurements to a neural QoS network 160 continuously trained with the provided latency measurements and past latency measurements, in order to produce a result of the current state and/or future state of the network latency with the neural QoS neural network.

FIG. 2 illustrates a workflow chart illustrating steps of the method 200. A first step 210 of the method 200 includes generating a plurality of measurable test data. In some embodiments, the test data may include a message, or a series of messages associated with different parameters, characteristics, or properties. The test data may be intended to be addressed to a recipient and sent through the network, in this case the monitoring server 110 and/or the target device 120. In some embodiments, test data can be generated based of known Internet Protocol (IP) protocols. For instance, the test data can be generated using various types of protocols to measure both network latency and application latency. In some embodiments, the monitoring server 110 can generate test data based on IP protocols such Internet Control Message Protocol (ICMP), Transmission Control Protocol/User Datagram Protocols (TCP/UDP), Hypertext Transfer Protocol/Secure (HTTP/S/3), Two-Way Active Management Protocol (TWAMP), among others, or based on industrial protocols such as Profinet™, Scada and Modbus, for instance. As can be appreciated, other parameters can be included to generate the test data and are not limited to those described herein. The plurality of test data can be synthetically generated and formatted data. Synthetically generated data can refer to data that are generated by the monitoring server 110 to be used for test measurements to replicate the behavior of other devices in the network. As can be appreciated, synthetically generated data differ from so-called organic data that are produced by devices within the network for the purpose of performing a particular function other than for testing. It can be appreciated that other forms of test data can also be considered. For instance, in some embodiments, organic data can be collected by the monitoring server 110 and used as part of the test data to make the measurements. In some embodiments, test data can be a combination of synthetically generated data and organic data.

In some embodiments, the plurality of test data can be generated based on latency parameters to be measured. In particular, the monitoring server 110 can determine in advance how often the test data will be generated and what type of data it will be. For instance, the monitoring server 110 can determine the amount of test data that should be generated and a predetermined type of protocol to which it should be associated. For example, the monitoring server 110 can be configured to test only the network latency, and thus could generate test data from a combination of ICMP and TWAMP protocols. Similarly, for a configuration where only application latency is to be measured, the monitoring server 110 can generate test data from the HTTP protocol. Similarly, the latency parameters to be measured can include a predetermined frequency indicative of how often the test data should be sent. For example, the monitoring server 110 can be configured to schedule the creation of test data and when it should be sent. In some cases, the latency parameters can also include the transmission time of the test data.

In some embodiments, the test packets can be generated with utilities provided with the monitoring server 110. For instance, in some embodiments, test data can be generated with known networking tools such as, for example and without being limitative, Traceroute and Iperf3. In some embodiments, the monitoring server 110 can also be configured to support other types of protocols and/or network performance measurement tools.

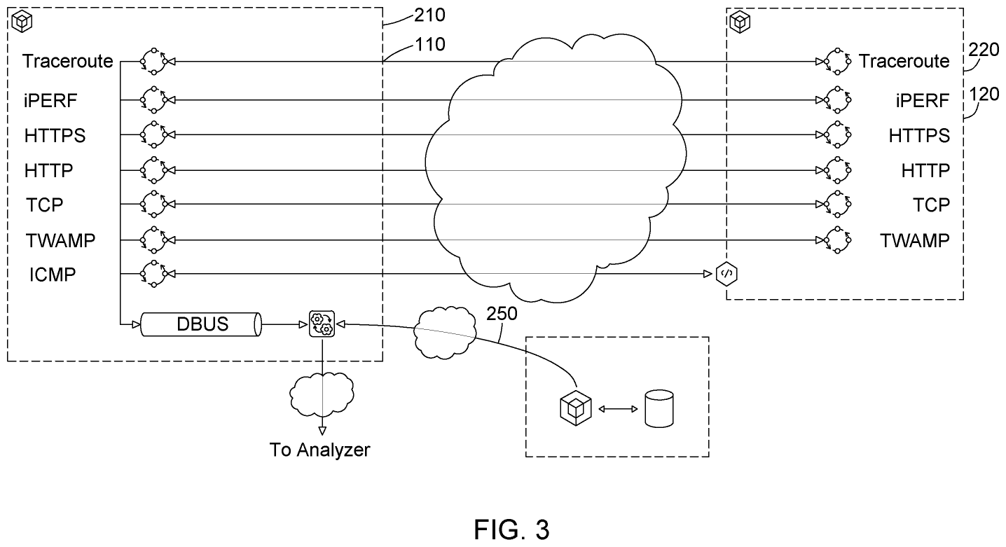

As illustrated in FIGS. 2 and 3, following the step of generating the plurality of test data 210, a subsequent step can include sending initial test packets to a target device 220. Test packets are derived from test data, and messages transmitted between two devices are divided into network packets during transmission. Accordingly, the monitoring server 110 is configured to segment the test data into a series of test packets that are then sent to the target device 120. The term “initial” herein refers to the test packets initially originating from the monitoring server 110. In some embodiments, the test packets can be sent to the target device 120 at the time the test data is generated. In some other embodiments, the monitoring server 110 can accumulate a set of test data before sending the corresponding test packets.

The transmission is made for each individual test data. That is, for each test data, initial test packets are transmitted to the target device 120. In some embodiments, the test packets of the test data can be sent in batch or separately. For instance, in some embodiments, the test packets can be transmitted according to a sequence defined by the monitoring server 110. For instance, this sequence can be defined according to the predetermined measurement parameters. As a non-limiting example, at 500 milliseconds, the monitoring server 110 can transmit test packets for data generated from TCP/UDP, ICMP, TWAMP and HTTP/S/3 protocols; at 1 second, the monitoring server 110 can transmit initial test packets for bandwidth tests with the iperf3 tool; and at 3 minutes can send test packets originating from a traceroute command executed by the monitoring server 110. As can be appreciated, this exemplary transmission sequence can be executed continuously, which means that once the traceroute command is executed, the sequence can start again. The transmission sequence can also be done periodically. For example, the sequence is executed at an interval predefined by the monitoring server 110. Of course, it can be understood that in other embodiments, other transmission sequences can also be considered and are not limited to the above-described examples.

In some embodiments, sending the test packets can be achieved directly, without intermediary between the monitoring server 110 and the target device 120. In some embodiments, the transmission can be done through network nodes that act as intermediaries between the endpoints. By intermediary, it is understood that the nodes simply relay the test data between the monitoring server 110 and the target device 120.

After sending the initial test packet 220, the following step 230 can involve receiving the initial test packets at the target device 120 and redirecting the initial test packets back to the monitoring device. Redirection mainly consists of sending the test packets back to its original source. For instance, the target device 120 can be configured to redirect the test packets to the monitoring device that sent the initial packets. In some embodiments, the redirection implies that all initial test packets received at the target device 120 are immediately sent back to the monitoring server 110. The target device 120 can identify the source address that transmitted the test packets and can then send them back to the monitoring server 110. In some embodiments, new packets can be sent back to the source. For example, the target device 120 can generate new test data, like those generated by the monitoring server 110, and transmit these new test packets back to the monitoring server 110. As can be appreciated, other embodiments are possible where the newly generated test data by the target device 120 can contain other information than that initially generated by the monitoring server 110.

In step 240, once the initial test packets are redirected back to the monitoring server 230, the redirected test packets are processed to obtain latency measurements between the transmission of the initial test packets and the reception of the redirected test packets. In some embodiments, the redirected test packets can be received in the same sequence as they were transmitted. For example, as shown in FIG. 3, the test packets are transmitted sequentially for each test data that is generated. Therefore, the monitoring server 110 process can be done individually for each redirected test packets following the same sequence. In some embodiments, the monitoring server 110 can be configured to wait to receive some or all of the redirected test packets before starting processing.

Processing redirected test packets to obtain latency measurements refers here to receiving information related to the transmission and reception time of test packets (i.e., initial and redirected). The latency measurements can include qualitative measures. For example, latency measurements can include time measures associated with test packet transmission. In some embodiments, obtaining latency measurements can include the propagation time, the transmission time, the routing time, the jitter time, and the queuing time between test packets in the network, among others. In some embodiments, latency measurements can include network latency and/or the Application latency, derived from the combination of packets from network data (e.g., ICMP and TWAMP) or packets from application data (HTTP/S or TCP). In some embodiments, the latency measurements can also include measurement of the network bandwidth, for example resulting from the bandwidth test made with the iperf3 tool.

In some embodiments, the obtained latency measurements can include complementary contextual data such as geolocation data, weather data, and information on the monitoring server 110. For example, the monitoring device can be configured to determine the location of the nodes through which the initial test packets and redirected packets have passed to and from the monitoring server 110 and the target device 120. By having the location of the nodes, the monitoring device can determine what the surrounding weather conditions are for each of the nodes, including the target device 120. In some embodiments, the geolocation data and weather data can be numerical, for example, coordinates of the node and temperature at the node location. In some embodiments, the geolocation data and weather data can be qualitative. For example, the geolocation data can correspond to the name of the physical location of the node (e.g., an address, the name of the city, or the country where the node is located), while weather data can correspond weather conditions at the node location (e.g., sunny, rainy, windy, etc.).

Upon obtaining the latency measurements of the test data 240, the following step involves transmitting the latency measurements to a processing server 250. In some embodiments, transmitting the latency measurements can involve transmitting the set of measurement data associated with the plurality of test data. For example, the monitoring server 110 can be configured to transmit the latency measurements once the transmit/receive sequence (steps 210 and 220) is completed for the plurality of test data. In some embodiments, the transmission can be carried out each time the latency measurement is obtained for each test data of the plurality of test data. For example, the monitoring server 110 can be configured to transmit latency measurements as it receives retransmitted test packets associated with a test data, without the transmission sequence being completed.

In some embodiments, the transmission of the latency measurements can involve publishing a message to a topic of the message bus of the processing server. The published message can contain the latency measurements obtained at the monitoring server 110. In some embodiments, the topic, provided by the processing server, can correspond to the monitoring server 110. As can be appreciated, each of the topics provided by the processing server can be associated to a corresponding monitoring server 110. Other transmission methods can also be considered.

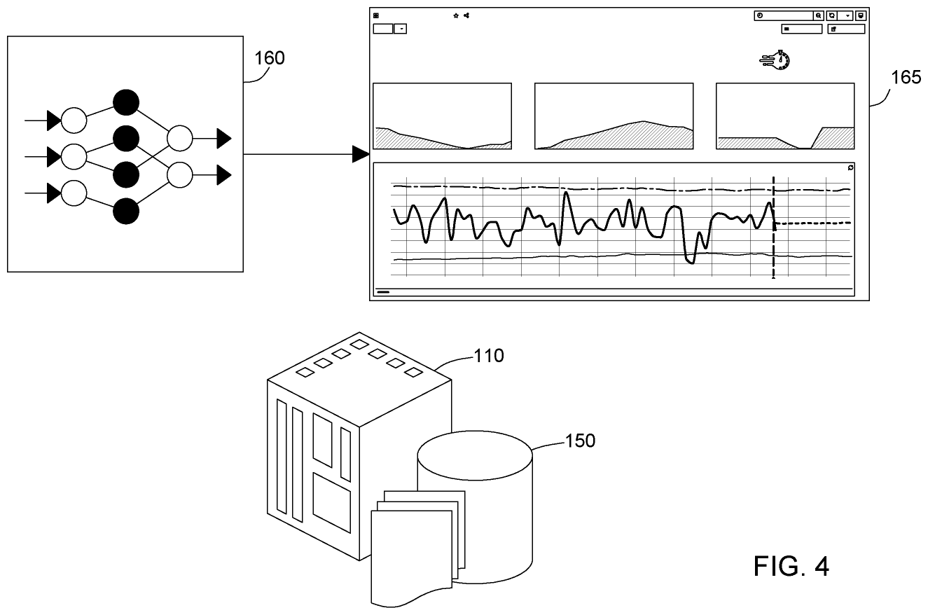

Now referring to FIGS. 2 and 4, once the latency measurements are transmitted to the processing server 250, the following step 260 involves receiving the latency measurements in a QoS neural network. The QoS neural network 160 is configured to produce a prediction of the current latency state and/or the future latency state. The current latency state herein refers to one or more indicators that identify the current state of the network. The current latency state can also include a past state of the network. The future latency state herein refers to one or more indicators that identify the state of the network in the future. For example, in some embodiments, the future latency state can include an estimate of latency in the next 2 to 5 minutes. Of note, it should be noted that the estimation of the future latency can range from more than 5 minutes. The QoS neural network can communicate with the processing server 110 to continuously receive the transmitted latency measurements by the monitoring server 110 and the latency measurements stored in the temporal database 150.

In some embodiments, the QoS neural network 160 is trained on the transmitted latency measurements and the latency measurements representative of past measurements. By past measurements, by latency measurements representative of past measurements, it is understood that these are latency measurements that have been transmitted in the past and that have been stored in part in the temporal database 150. For example, once the latency measurements are received by the processing server 110, the processing server 110 can be configured to label the latency measurements with the epoch timestamp and store them in the temporal database 150, for subsequent input into the QoS neural network 160. In some embodiments, the processing server 110 can be configured to label the latency measurements upon receipt thereof and input them directly into the QoS neural network 160.

In some embodiments, the QoS neural network 160 can use an evolutive statistical extrapolation model, or machine learning model adapted to operate continuously. By evolutive, it is understood that the QoS neural network 160 model can be configured to continuously be trained with newly received latency measurements. For example, since the state of the network can be in continuous evolution (i.e., may temporally change), the model can be trained with the newly received latency measurements in addition to the past measurements. As it can be appreciated, the use of an evolutive model that can be continuously trained allows to keep pace with the constant variation of the network and to have a prediction that accurately represents the current network state.

Once the latency measurements are received 260 in the QoS neural network 160, a step 270 of producing the current latency state and/or the future latency state is carried out. In some embodiments, the QoS neural network 160 can include or use more than one machine learning models. Each machine learning model can be trained to produce indications of the current latency state and/or a future latency state. More specifically, the QoS neural network 160 can include an anomaly detection model, a future prediction model, and a sub-components decomposition model. Other models can also be considered or used, depending on the targeted application.

The anomaly detection model will now be described in greater detail. One of the objectives of the anomaly detection mode is to detect or recognize abnormal variations in response times, such as the ones associated with TCP or HTTP protocols, for example, and to produce a notification in real time or near real time, the notification being representative of a presence of an anomaly. In some embodiments, the anomaly detection may be carried out within a 1 second time window after having received the relevant data. In some embodiments, the anomaly detection may be carried out within a 20 millisecond time window after having received the relevant data. As previously mentioned, once an anomaly has been detected, a notification and/or an alarm is produced or outputted. The notifications can be stored or saved in a database, such as the temporal database 150, (e.g., InfluxDB) for future reference such as viewing or reviewing purposes. Of note, a single anomaly may sometimes be “ignored”, i.e., will not cause the production of a notification, as a single anomaly may sometimes not be representative of an actual problem in the network. However, when several abnormal events are detected in a relative short period of time, then these anomalies will be considered and treated as an incident in the network. The anomalies can be detected either by using a machine learning model or by using a statistical approach, which may include analyzing standard deviation variances.

The future prediction model will now be described in greater detail. One of the objectives of the future prediction model is to anticipate or predict network problems. In some embodiments, the future prediction model may be useful to detect or recognize relatively large variations in response times or latency. In some embodiments, the future prediction model may be used to produce, generate, or output an alert or a notification indicating that a potential problem has been forecasted or predicted in the network. The future prediction model uses or relies on a statistical extrapolation model, other statistical methods, a machine-learning model (such as univariate and/or multivariate convolutional networks), or any combinations thereof, and is configured to continuously monitor the future latency of the network. In some embodiments, the future prediction model may be configured to predict the latency in the network for the upcoming two to five minutes. When the prediction exceeds a predefined or predetermined threshold or a given value, then the future prediction model is configured to produce an alert or a notification and send the same to relevant agent or interface. The future prediction model may be used in contexts in which speed of execution of the prediction tool is more desirable rather than the accuracy of the prediction. As ultra-low latency is typically calculated in milliseconds, it would not be conceivable to future prediction model for several minutes. As such, the future prediction model is a trade-off between speed (target is typically between three and four milliseconds) and precision. The future prediction model provides satisfying results in a relatively short period of time, even if false positives are sometimes identified. In order to refine or fine-tune the results provided by the future prediction model, it is possible to determine the distribution of the future prediction model across several endpoints (e.g., devices, EDGE, and cloud locations). These predictions can then be stored in the temporal database 150, or another separated database, and be used for real-time or near real-time visualization.

The sub-components decomposition model will now be described in greater detail. The sub-component decomposition model of the response time (or latency) of the network provides insights about potential causes of relatively high variances latency. The sub-components decomposition model includes analyzing, in real time or near real time, the sub-components of the latency, such as, for example and without being limitative, transmission time, propagation time, routing time, queuing time, jitter, and other relevant parameters. These results allow customers (e.g., mobile operators) to take palliative and/or preventive measures to improve the quality of the network, notably in terms of latency. Characterizing the sub-components of latency may also include determining propagation time, transmission time, routing and queuing time (in routers), jitter time, as well as network path nodes that seem to be slower than normal. The detected sub-components can be stored in a database, such as the temporal database 150, for real-time or near real-time visualization, or future reference.

In some embodiments, the current latency state and/or the future latency state can be provided by a network stability estimation model, represented by equation (1) presented below. The network connection stability estimation model allows to generate a network stability score (real-time latency volatility score) and allows to see the state of the network volatility under a single value. The network connection stability score can be expressed as a set of key factors such as, but not limited to, the standard deviation of the latency measurements (σ), the average of the latency measurements (x̅), the number of protocols (n), the number of samples collected for a given protocol i (κᵢ), the number of events observed for the protocol i (εᵢ), the number of samples collected for protocol i (δᵢ). In some embodiments, the samples, i.e., κᵢ, εᵢ, δᵢ, are collected during the same time range (or during a same time period).

$$network stability = ( 1 - \frac{σ}{\overline{x}} ) \times ( 1 - \frac{{\sum }_{i = 1}^{π} \frac{{ε}_{i}}{{κ}_{i}}}{n} ) \times ( 1 - \frac{{\sum }_{i = 1}^{π} \frac{{δ}_{i}}{{κ}_{i}}}{n} ) \qquad ( 1 )$$

The processing server 110 can be configured to provide the latency states produced by the QoS neural network 160 to users. For example, the predictions provided by the QoS neural network 160 can be displayed on a graphical user interface (GUI) provided by the processing server 110. In some embodiments, the user can have access to a dashboard 165 containing or illustrating results derived from the predictions of the QoS neural network 160, or visual representations associated with these predictions.

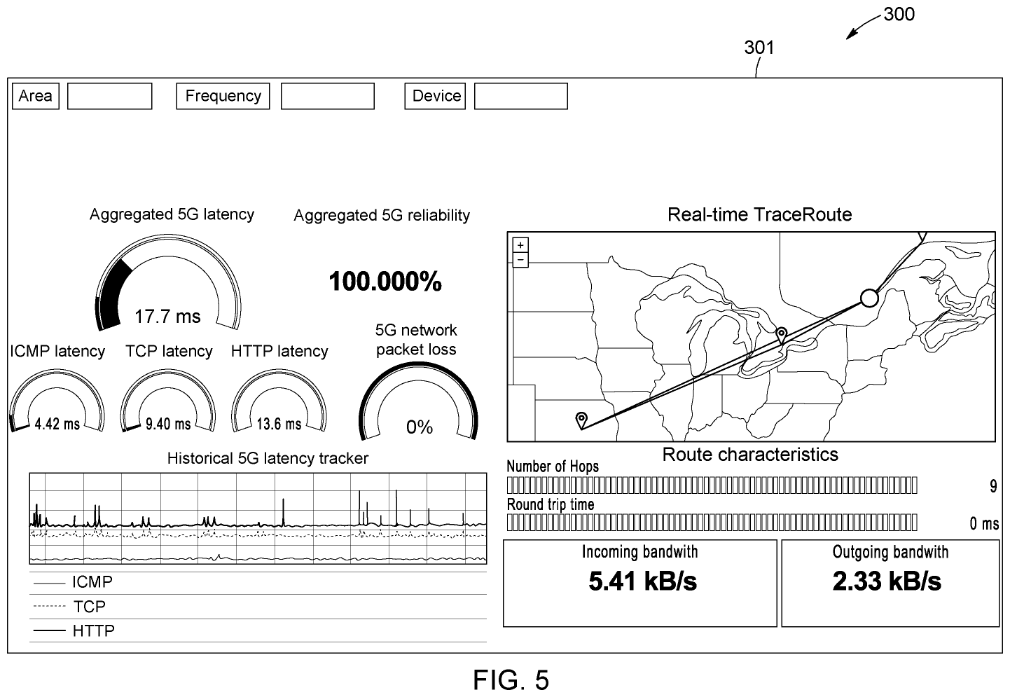

Referring now to FIGS. 5 to 9, some results that can be obtained with the techniques having been insofar described will be presented. In FIGS. 5 to 9, screenshots or panels of the graphical user interface (GUI) 300 are illustrated. As shown, the user can be presented with information relating to the network state. As can be appreciated, such information can be provided based on the results outputted by the monitoring method 200. The GUI 300 can comprise one or several pages provided by the processing server to the user devices 140 a, 140b. Accordingly, a user can have access to the GUI 300 via a personal computer, a smart tablet and/or a smart phone, among others, adapted to display such interface. In particular, the user can be presented with different results related to the output of the various machine learning models provided by the method 200, including the analytical decomposition of network latency, a real-time prediction of the network latency, and a display of detection of potential latency anomalies.

FIG. 5 is a screenshot presented on the user device 140a, 140b of the main section 301 of the interface 300 (i.e., the main dashboard). As shown in FIG. 5, the user can have access to general information about the ongoing network state. For example, the GUI 300 can display the current latency of the main protocols, i.e., ICMP, HTTP and TCP, as well as a status of the network throughput (inbound/outbound) and latency history. The GUI 300 can also display a map showing the path of the network traffic, as well as an indication of the location of the nodes (other devices) through which the network traffic travels.

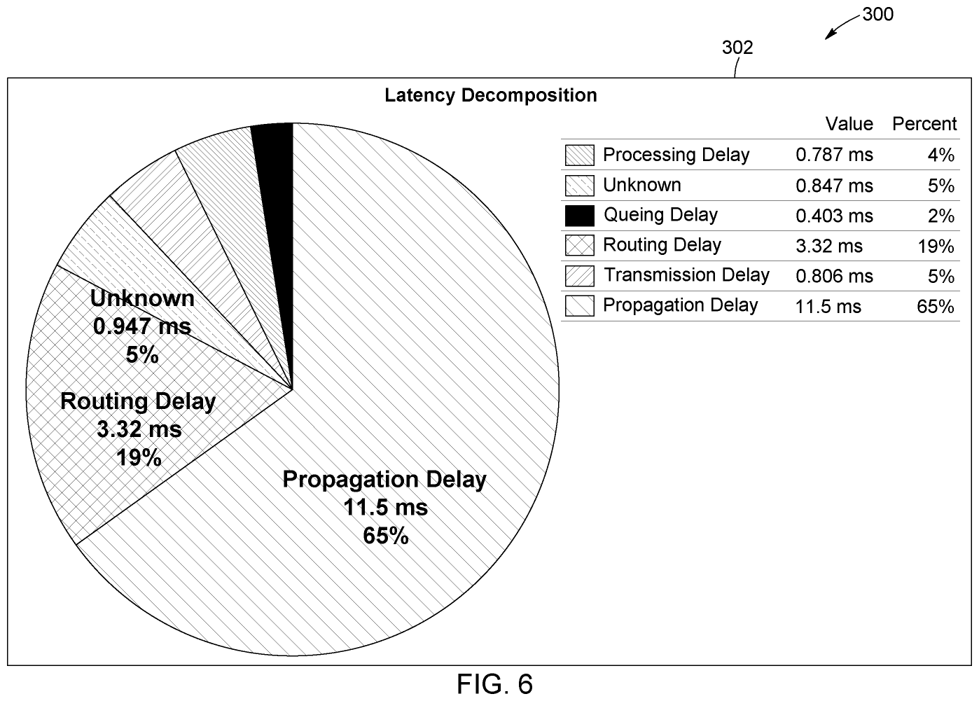

FIG. 6 shows a latency decomposition menu 302 of the GUI 300, indicating the analytical decomposition of network latency. As can be appreciated, the user can view, the distribution of the different factors causing latency in the network, as well as the associated delay time in milliseconds. In the illustrated embodiment, the latency factor distribution is represented in the form of a pie chart. However, it can be appreciated that other forms of representation are possible.

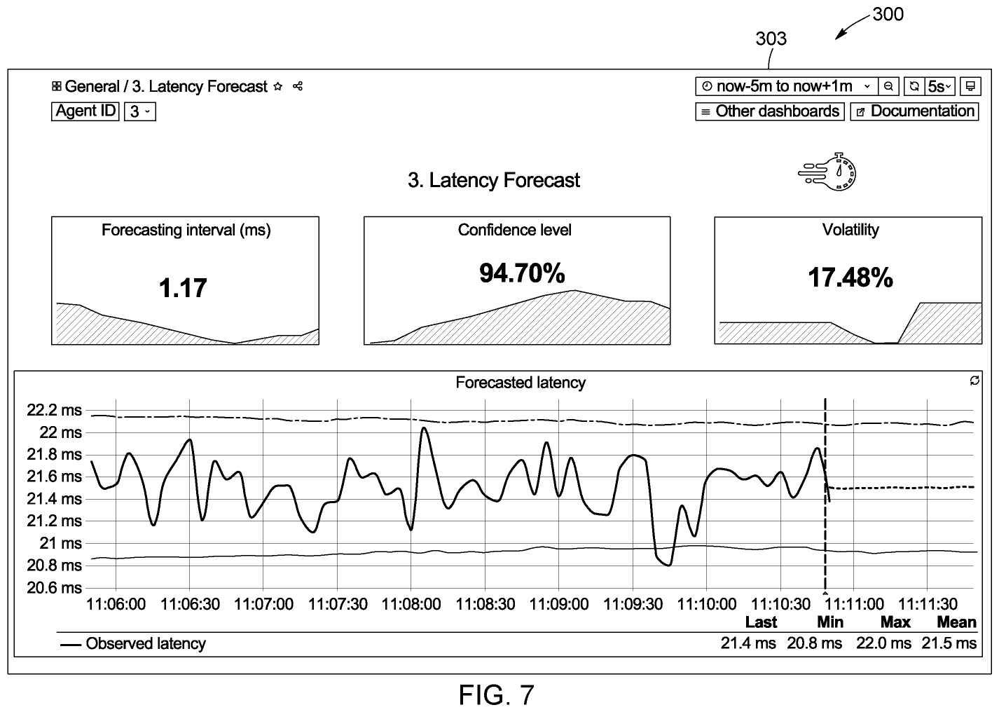

FIG. 7 shows a latency prediction menu 303 of the GUI 300, indicating the real-time prediction of the average network latency based on available latency results. The graphs of menu 303 allow the user to see the observed network latency in real time, as well as the upper and lower predictions of the latency for the upcoming minutes. The system can trigger an alarm if the predicted latency is above a pre-set threshold.

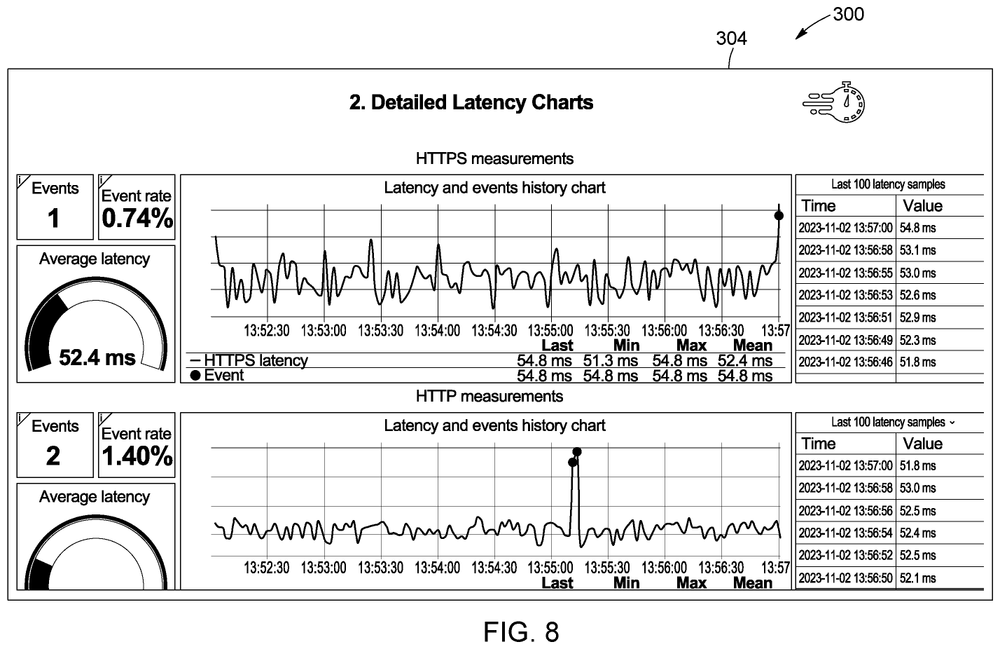

FIG. 8 shows a detailed latency charts per protocol menu 304 of the GUI 300. The graphs of menu 304 allow the user to consult the past and current latency variation in real time for each protocol used. As shown, the graphs show the user when the protocol-based latency exceeds given thresholds by displaying the anomaly as a red dot. For instance, in the top graph, the red point is shown as the latency exceeded a predefined limit. The system can also send an immediate alert to the user.

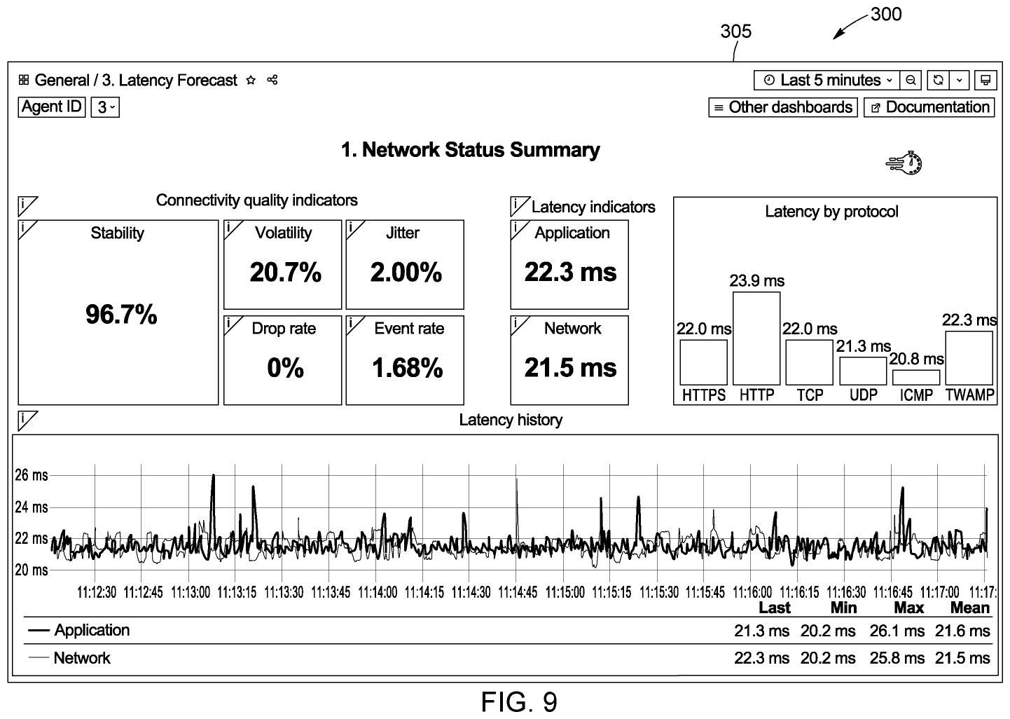

FIG. 9 shows a compact summary menu 305 (or Network Summary Status dashboard) of the GUI 300. The menu 305 shows a brief version of the status of the quality of service (QoS) indicators that is considered essential or particularly relevant. For instance, the menu offers a general overview of the network stability. As indicated, this overview can be provided in the form of an overall network stability score, for example illustrated as a percentage. For instance, it can be appreciated that providing a real-time latency volatility score can be beneficial for mission-critical applications in which the stability of an upper-bounded latency connectivity is highly important, since these applications can often have difficulties to adapt due to a high variability and instability in the network. As can be appreciated, the user can get a quick idea of the network status, without having to analyze the measured data in depth. Also provided are a real-time latency volatility, jitter and packet loss as percentage providing a quick assessment of the performance of the connectivity.

It should be noted that the GUI 300 is not limited to the menus disclosed above and can provide/display other features and functionalities to the user.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. A method for monitoring a quality of service (QoS) of a cellular network, comprising steps of:
generating, using a monitoring module, test data based on latency parameters, the test data comprising initial test packets;
transmitting the initial test packets of the test data to a target module;
upon reception of the initial test packets, transmitting, using the target module, redirected test packets back to the monitoring module, the redirected test packets associated with the initial test packets;
upon reception of the redirected test packets at the monitoring module, processing, using the monitoring module, the redirected test packets to calculate latency measurements between transmission of the initial test packets and reception of the redirected test packets;
transmitting the latency measurements to a processing module comprising a QoS neural network; and
producing at least one of a current latency state and a future latency state using the QoS neural network, the current and future latency states indicative of a current and future QoS of the cellular network, respectively.

2. The method of claim 1, wherein transmitting the redirected test packets back to the monitoring module comprises one of:
transmitting test packets generated by the target module and associated with respective initial test packets; and
redirecting the initial test packets to the monitoring module.

3. The method of claim 1, wherein the one or more latency parameters include a class of measurements and a frequency of measurements.

4. The method of claim 3, wherein the class of measurements includes a communication protocol for generating the test data, the communication protocol being selected from a group including an Internet Control Message Protocol (ICMP), a Transmission Control Protocol (TCP), a User Datagram Protocol (UDP), a secure Hypertext Transfer Protocol (HTTP/S/3) and a Two-Way Active Management Protocol (TWAMP).

5. The method of claim 3, wherein the frequency of measurements comprises a measurement cycle, and wherein test data is periodically generated based on the measurement cycle.

6. The method of claim 1, wherein the QoS neural network is trained with the latency measurements and past latency measurements.

7. The method of claim 6, further comprising labelling the latency measurements using epoch timestamps, and wherein the QoS neural network is trained using labelled latency measurements.

8. The method of claim 1, wherein the QoS neural network is one of an evolutive statistical extrapolation model, and a machine learning model adapted to operate continuously.

9. The method of claim 1, wherein the QoS neural network comprises an anomaly detection model, and wherein the method further comprises steps of:
detecting, using the QoS neural network, abnormal variations in response times based on the latency measurements; and
generating an alert when an anomaly is detected, indicative that one or more abnormal variations have been detected.

10. The method of claim 1, wherein the QoS neural network comprises a future prediction model, and wherein the method further comprises steps of:
predicting, using the QoS neural network, future network problems; and
generating an alert when a future network problem is predicted.

11. The method of claim 1, wherein the QoS neural network comprises a sub-components decomposition model, and wherein the method further comprises a step of calculating sub-components of latency including transmission time, propagation time, routing time, queuing time, and jitter.

12. The method of claim 1, wherein generating the test data comprises continuously generating new test data, each new test data comprising a plurality of the initial test packets.

13. The method of claim 1, wherein the steps are performed in real-time.

14. The method of claim 1, wherein producing the at least one of the current latency state and the future latency state comprises calculating, using a network stability estimation model, a network stability score defined as
$$network stability score = ( 1 - \frac{σ}{\overline{x}} ) \times ( 1 - \frac{{\sum }_{i = 1}^{π} \frac{{ε}_{i}}{{κ}_{i}}}{n} ) \times ( 1 - \frac{{\sum }_{i = 1}^{π} \frac{{δ}_{i}}{{κ}_{i}}}{n} )$$
where: σ is the standard deviation of the latency measurements, x̅ is the average of the latency measurements, n is the number of protocols, i (κ i) is the number of samples collected for a given protocol, i (ε i) is the number of events observed for the protocol and i (δ i) is the number of samples collected.

15. The method of claim 1, wherein generating the test data comprises one of:
generating synthetically generated data used for testing purposes; and
collecting organically generated data transmitted through the network and using the organically generated data as the test data.

16. The method of claim 1, wherein calculating the latency measurements further comprises calculating network bandwidth.

17. The method of claim 1, further comprising a step of determining a location of one or more nodes traversed by the data packets, and wherein the latency measurements include complementary contextual data based on the one or more nodes traversed.

18. The method of claim 17, wherein the complementary contextual data includes one of weather data and geolocation data.

19. A system for monitoring a quality of service (QoS) of a cellular network, the system comprising:
a monitoring module configured:
to generate test data based on latency parameters to be measured, the test data comprising initial test packets;
transmit the initial test packets to a target device;
receive redirected test packets from the target device, the redirected test packets associated with the initial test packets; and
process the redirected test packets to calculate latency measurements between transmission of the initial test packets and reception of the redirected test packets; and
a processing module operatively connected with the monitoring module and comprising a QoS neural network, the processing module being configured to receive the latency measurements from the monitoring module and to produce at least one of a current latency state and a future latency state.

20. A system for monitoring a quality of service (QoS) of a cellular network, the system comprising:
a monitoring module configured to generate test data based on latency parameters to be measured, the test data comprising initial test packets;
a target module operatively connected to the monitoring module, the target module being configured to:
receive, from the monitoring module, the initial test packets; and
transmit redirected test packets back to the monitoring module;
the monitoring module being further configured to process the redirected test packets to calculate latency measurements between transmission of the initial test packets and reception of the redirected test packets;
a processing module operatively connected with the monitoring module and comprising a QoS neural network, the processing module being configured to receive the latency measurements from the monitoring module and to produce at least one of a current latency state and a future latency state.

21. The system of claim 20, further comprising an application programming interface adapted to transmit the at least one of a current latency state and a future latency state to a user device.

22. A computer-readable medium comprising computer-readable instructions stored thereon that, when executed by a computer, perform the steps of claim 1.
